(19) United States
(12) Patent Application Publication
(10) Pub. No.: US 2006/0130073 A1
(43) Pub. Date: Jun. 15, 2006

(54) System configuration and process in a control system for identifying nonequivalent functionality between the software of a device and the assigned device driver

(76) Inventors: Fridolin Faist, Oberwolfach (DE); Andreas Isenmann, Haslach (DE)

Correspondence Address: NATH & ASSOCIATES, PLLC, Sixth Floor, 1030 15th Street, N.W., Washington, DC, 20005, US

(21) Appl. No.: 11/280,394

(22) Filed: Nov. 17, 2005

(30) Foreign Application Priority Data
Nov. 19, 2004 (DE) 10 2004 055 993.7

(51) Int. Cl. G06F 9/46

(52) U.S. Cl. 719/321

(57) ABSTRACT

The invention relates to a process in a control system for identifying nonequivalent functionality between a device software and an assigned device driver, in which information (TR-ID) identifying a given version of the device driver and/or information (SW-ID) identifying a given version of the device software is transmitted between a device control mechanism (GC) and a device (G) over an interface (CI, GI) between said device control mechanism (GC) and said device (G); the information (TR-ID) identifying a given version of the device driver and the information (SW-ID) identifying a given version of the device software are compared with respect to functional equivalence; and an update is executed in the case of functional nonequivalence and/or an error announcement is issued. The invention also relates to a system configuration for implementing such a process.

The invention relates to a process in a control system for identifying nonequivalent functionality between the software of a device and the assigned device driver, as indicated in the features of the preamble to claim 1, and to a process in a control system for identifying nonequivalent functionality between the software of a device and the assigned device driver.

In the field of measuring and control technology, as well as that of processing systems, where sensors or actuators are connected to a control system or an analytic system, an increasing number of adjustable functions have become available. In order to adjust these functions, devices drivers and software components are available which precisely cover the functional scope of the individual device.

In measuring and control technology an increasing number of devices have a micro-controller at their disposal. The range of functions available in these devices is determined not only by the hardware but also, and in essential ways, by the device software. The result is that devices with identical hardware will differ functionally, specifically as dependent on the software installed in the device.

A modification in the device software usually serves to eliminate an error in the existing device software and/or serves to enlarge the former functional scope through the addition of new functions.

Among such devices found in measuring and control technology there are often software components which serve to maintain, diagnose, and assign parameters to the devices. These software components are called device drivers. The device drivers are not part of the actual device but belong, e.g., to a normal personal computer serving as an external control computer or as an external receptacle (e.g., a memory stick) for the device. The functional scope of a device driver must reflect the functional scope of the corresponding device.

If the functional scope of the device can be modified by an update to the device software it is evident that the modification may cause conflict between the device driver and the device software. Problems will not arise in the case of a device driver with a basic range of functions and a corresponding firmware or software with a basic range of functions. However, if the software is provided with an enlarged range of functions the device driver cannot support this enlarged functionality and the device user cannot utilize the available range of functions. Problems will not arise when a device driver with an enlarged range of functions also has a software or firmware with an enlarged range of functions. However, if the software lacks the enlarged functionality, the device driver offers the user a range of functions which are not available to the device.

In order to resolve such conflicts it is necessary for the user to interactively eliminate the incompatibility between the device driver and the device software. The user must install compatible software versions, i.e., device software and a compatible device driver, in the involved modules, e.g., a device, on the one hand, and the control computer, on the other. The user is obliged to research the selection of compatible software versions. Under certain circumstances, a situation involving a conflict is entirely unknown to the user of the device because he is using only the range of functions provided by the device driver, not those actually present in the device.

The goal of the invention is to provide a system configuration and a process in a control system for identifying nonequivalent functionality between device software and the assigned device driver.

This problem is solved by a system configuration in a control system for identifying nonequivalent functionality between device software and the assigned device driver with the features of patent claim 1, and by a process with the features of patent claim 7.

Particularly preferred is a system configuration and a process in a control system for identifying nonequivalent functionality between a device software and the assigned device driver, with a device control mechanism containing the momentary version of the device driver; with a device containing the momentary version of the device software; and with an interface between the device control mechanism and the device, which interface serves the purpose of controlling the device by means of the device control mechanism; and where there is a comparative module for comparing the device driver version with the device software version with respect to compatibility, and for executing an update or an error notice in the case of incompatibility.

The preferred process is a one belonging to a control system for identifying nonequivalent functionality between a device software and the assigned device driver, where information on the version of the device driver and/or information on the version of the device software is transmitted between a device control mechanism and a device, over an interface between the device control mechanism and the device; the information on the version of the device driver and the information on the version of the device software are compared with regard to compatibility of functions; and an update is performed and/or an error notice issued in the case of incompatibility.

Thus a software arrangement and/or a process is described which automatically identify whether the functional range of a device software, and thus of the device, agrees with the device driver. When so required an update for the device driver and/or the device software can be automatically released for the version that must be matched.

Particularly preferred is a system configuration with a memory for storing a data bank, in which, for each device function and/or each version of the device driver, information is deposited on the version of the device software starting with which the given device function or the given version of the device driver is supported, while the interface for transmitting information identifying the device software and/or information identifying a device driver, as required by the device software, is provided in order to feed said information to the comparative module.

Particularly preferred is a system configuration in which the device software is assigned information on the version of the device driver starting with which the functionality of a given version of the device software is completely contained.

Particularly preferred is a system configuration in which the comparative module is designed so as to evaluate information on the different versions of the device driver and the device software, and to identify existing conflicts with respect to nonequivalent functionality.

Particularly preferred is a system configuration in which the comparative module is designed so as to trigger an update mechanism for the device software and/or the device driver.

Particularly preferred is a system configuration with an interface for inputting device drivers and/or device software from an external source, particularly from a data carrier or an external data file server.

Particularly preferred is a process which a data bank in the device control mechanism and/or in the device is accessed for the purpose of comparison, and for each device function and/or each version of the device driver information is deposited in the data bank on the version of the device software starting with which the given device function or the given version of the driver is supported.

Particularly preferred is a process in which information is linked to the device software version, which information indicates the version of the device driver starting with which the functionality of the given device software version is completely contained, and this information is used for the purpose of comparison.

Particularly preferred is a process in which the comparison is performed in conjunction with a connecting structure between the device control mechanism and the device, and/or the device driver and the device software.

Particularly preferred is a process in which information is also linked to the version of device software and/or the version of the device driver, which information indicates the device hardware that is compatible with the device software or the device driver.

Particularly preferred is a process in which an update mechanism for the device software and/or the device driver is automatically triggered when there is a case of non-compatibility.

Particularly preferred is a process in which data and/or programs required for updating are downloaded from an external source, particularly from a data carrier or an external data file server.

Particularly preferred is a process in which the version of the device driver required by the device software is installed in the update.

Particularly preferred is a process in which the newest existing version of the device driver and/or the device software is installed in the update.

Particularly preferred is a process in which a selective list of available and matching versions of the device driver and/or the device software are displayed to the user during the update, for selection of the versions to be installed.

Particularly preferred is a process in which the device software that matches the device driver is a component part of the device driver and this device software is directly transmitted from the device driver into the device.

An advantageous feature rests in the fact that the user of the device is not forced to research which device driver software matches the software of the device. Particularly in cases where the user is unaware of a case of incompatibility, a device malfunction relative to instructions given by the device control mechanism will be avoided. The system independently identifies the need for an update. Detection of matching software will preferably occur in automatic fashion. The input of matching software is simplified or is completely automated.

The device driver will preferably include a data bank containing a correlation of device functionalities relative to corresponding versions of the device software and the device driver. The device driver can provide all functions known to it offline and can perform an adjustment even, e.g., in the case of an online avenue of information to an external source or to the device.

As an option for cases where problems that cannot be automatically remedied arise relating to an update requirement, an update requirement can be issued in the form of a notice to the user.

The device will preferably provide information on the appropriate version of the device driver, as read by the device driver when an online connection has been made between the device control mechanism and the device.

An exemplary embodiment is next described in greater detail, as based on the drawing. Shown are:

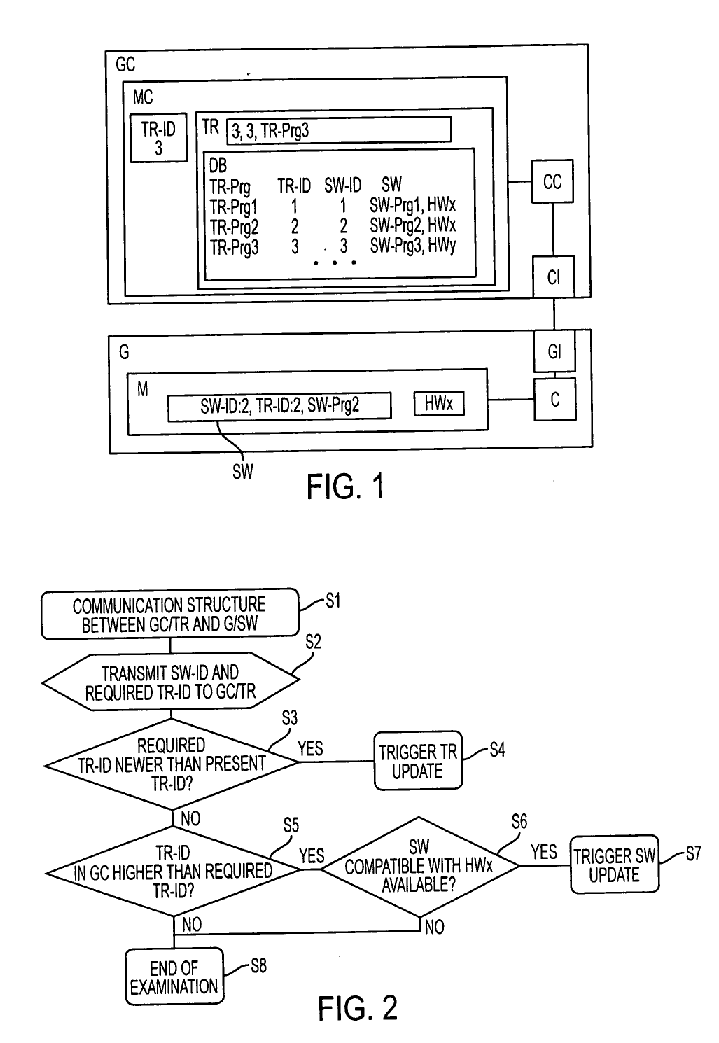

FIG. 1 schematic components of a device, with installed device software and a control mechanism containing the installed device driver

FIG. 2 an exemplary process sequence for updating the device driver and the device software in a common version

FIG. 1 schematically depicts a device G with a processor C for controlling the functional range of the device G. Data and programs which are necessary for control and operation of the processor C are stored in a memory M. To control the functional range of the device G or the processor C there is device software SW, which is stored in the memory M. The device software SW consists of an actual software program SW-Prg2 for controlling the processor C, and also of a software identification number SW-ID and preferably a correlated device driver identification number TR-ID. The depicted example deals with a device software SW in a second stage version, with software identification number SW-ID 2 and software program SW-Prg2. Assigned to this device software SW is a device driver TR, with the device driver identification number TR-ID 2. Preferably there will also be stored in the memory M hardware information HWx, which is assigned to the device software SW and which indicates the device type or the device design level of the device G for which the device software GW is suitable.

Serving to control the device G is a device control mechanism GC, which can be provided as an integrated component of the device G, or as an external component. The device control mechanism GC specifically comprises a processor CC, a memory MC, and a control mechanism interface CI. The control mechanism interface CI serves to exchange data and control instructions with a device interface GI belonging to the device G. In this way the processors C, CC of the device G and the device control mechanism GC can communicate with each other and exchange data and control instructions.

Stored in the memory MC of the device control mechanism GC is a device driver TR for controlling the device G by means of the processor CC belonging to the device control mechanism GC. At the present moment, the stored device driver TR corresponds to a third version, with a device driver identification number TR-ID 3, and is designed to control a third version of the device software, which has a device software identification number SW-ID 3. A third device driver program TR-Prg3 is accordingly stored to exercise the control function. Thus a conflict is at hand between the device driver TR and the device software SW of the device G attached to the device control mechanism GC.

The memory MC of the device control mechanism GC additionally comprises a data bank DB. Different versions of the device software SW are stored in the data bank DB. In addition, for each device software SW, information is stored giving the device driver identification number TR-ID assigned to this device software SW, as well as information giving the device software identification number SW-ID pertaining to the device software SW. As a further option, it is possible to store hardware information HWx, HWy concerning the device hardware on which the device software SW is able to run.

In the communication structure between the device control mechanism GC and the device G across the control mechanism interface CI and the device interface GI, the appropriate identification numbers TR-ID, SW-ID for the versions of the device driver TR and the device software SW that are correlated at the given moment are initially transmitted to the processors C, CC and compared with each other. One or both of the processors CC, C will serve as a comparative module for comparing the identification numbers TR-ID, SW-ID and for the releasing an update immediately thereafter, if the transmitted identification numbers do not match. In this way it is selectively possible to update the device driver TR in the device control mechanism GC and/or the device software SW in the device G, so that the device can then operate with matching software, i.e., matching device driver TR and device software SW, under control of the device control mechanism GC.

FIG. 2 shows by way of example the steps of a process for comparing a momentary device software, or device software version SW-ID, with a momentary device driver TR, or momentary device driver version TR-ID. Here the device driver version is recognized by the device driver identification number TR-ID, and the device software version is recognized by the device software identification number SW-ID.

In the first procedural step S1 communication is established between the device control mechanism GC, or the device driver TR, and the device G, or the device software SW, over the interface formed by the control mechanism interface CI and the device interface GI. The information on the specific version can be transmitted in the desired direction, for processing either with the processor C of the device G serving as a comparative module, or the processor CC of the device control mechanism GC. Preferred, however, in accordance with the second procedural step S2, is the transmission of the device software version, or the device software identification number (SW-ID), with, e.g., a value 2, from the device G to the device control mechanism GC. In an optional and preferred operation, the required version of the device driver will also be transmitted to the device control mechanism GC. The appropriate device driver version will preferably be stored in the memory M of the device G as device driver identification number TR-ID 2, together with the device software SW.

In the following procedural step S3, the processor CC in the device control mechanism GC performs a comparison to determine whether the required version of the device driver is newer than the present version of the device driver TR. If yes, an update to the device driver TR is performed in the next procedural step S4. If no—as is the case in the present example—an inquiry is made in the following procedural step S5 as to whether the present device driver TR in its momentary version, with device driver identification number TR-ID3, provides a greater functional range than does the device software SW present in the device G. If yes—as is the case in FIG. 1—the next procedural step S6 performs an examination to determine the availability of device software SW that is compatible with the hardware, or the device G. If the result of these two stages of inquiry S5, S6 is no, the next procedural step completes the examination for compatibility. In the alternative case, the next step S7 triggers an update to the device software SW in the device G. The device software SW is brought to a more current status in order to permit the complete utilization of the range of functions provided by the device driver TR and/or to remove errors in the previous version of the device software.

The system configuration and the procedural design permit the identification of equivalent or nonequivalent functionality between the device software SW and the device driver TR.

To this end, it is preferred that the following information be employed. The device driver TR contains the data bank DB, in which are stored the available device functions, as well as the device software version SW-ID required to support those functions. In addition to information on the version of the device software, in the form of the device software identification number SW-ID, the device software SW also makes available information indicating the version of device driver TR starting with which the range of functions present in the device is completely supported. As a further option, the device software SW will also provide a list of the hardware versions compatible with the device software, i.e., hardware information HWx on possible device versions.

It is preferred that the identification of cases of possible conflict or incompatibility be performed by the communication structure between the device control mechanism GC, or device driver TR, on one side, and the device G, or device software SW, on the other side. At this point in the procedure, the device software SW transmits its own software version, as well as that version of the device driver TR (S1, S2) containing the complete functional range of the device software SW.

The version of the device driver TR required by the device software SW is then compared with the actual version of the installed device driver TR; this comparison is performed by the device driver TR, or the assigned processor CC serving as a comparative module (S3). If the comparison shows that the installed version of the device driver TR is too old, the update mechanism for the device driver TR is triggered (S4). Then the processor makes a comparison with respect to the device driver TR, as based on the data bank DB contained in the device driver TR or in the memory M, and determines whether the functionality of the device can be adjusted by means of an update to the device software SW (S5, S6). If this is the case, the update mechanism is started for the device software SW.

The update mechanism for the device software SW examines whether a version of the device software SW is compatible with the present hardware version of the device G. The device software SW can determine the present hardware version, e.g., by reading out a non-transient memory in the device G, in which information on the hardware version is stored at the time of manufacture; or by a module test of the hardware, or device G; or by an evaluation of the solder bridges.

The update mechanism for the device driver TR can function in various ways. In a simple version the contents are read in from an external data carrier, for example, a disk in a disk reader serving as an external interface I of the device control mechanism GC. When the device control mechanism GC is a computer, it is preferred that the user be requested to specify a memory site at which an installation program for the device driver TR, as required for the update, is located.

Particularly preferred is an update performed with an external interface I over an internet-based connection to a data file server, from which various versions of the device driver TR and/or the device software SW can be drawn. If, in addition to the version required by the device software SW, still newer versions of the device driver TR are available from the date file server, various options are available for choosing the version to be installed. For example, the new version can be automatically installed. As an alternative, the version of the device driver required by the device software SW can be installed. The user can be asked to select which among all possible versions is the one to be installed. Here all versions will be listed, from that required by the device software SW up to the newest version.

It is also possible to perform an update to the various versions of the device software. The update mechanism for updating the device software SW functions in a fashion analogous to the update mechanism for the device driver TR. The preferred option, however, is that the device software SW will already be contained in the device driver TR, as described in relation to FIG. 1. Thus, it will be possible to directly transfer this device software SW to the device G. In addition, for each version of the device software SW, it is possible to store hardware information HWx indicating which hardware versions are compatible with the given device software SW. This will eliminate the possibility of installing device software SW on incompatible hardware.

1. System configuration in a control system for identifying nonequivalent functionality between a device software (SW) and an assigned device driver (TR), with
a device control mechanism (GC) containing the device driver (TR) provided by a given, momentary device driver version (TR-ID),
a device (G) containing the device software (SW) provided by a momentary device software version (SW-ID), and
an interface (CI, GI) between the device control mechanism (GC) and the device (G), for controlling the device (G) by means of the device control mechanism (GC), wherein
there is provided a comparative module (CC, C) for comparing the device driver version (TR-ID) and the device software version (SW-ID) with respect to their functional equivalence and for initiating an update or an error notice in the case in functional nonequivalence.

2. System configuration according claim 1, with a memory (MC) for storing a data bank (DB), in which data bank (DB) there is stored for every device function and/or every device driver version (TR-ID) information on the device software version (SW-ID) starting with which the given device function or the given device driver version is supported, while the interface (CI, GI) for transmitting the device software identifying information (SW-ID), and/or the device driver identifying information (TR-ID), as called for by the device software (SW), is designed so that said information can be fed to the comparative module.

3. System configuration according to, claim 1 in which the given version of the device software has assigned to it information (TR-ID) on the version of the device driver starting with which the functionality of the given version of the device software (SW-ID) is completely contained.

4. System configuration according to, claim 1, in which the comparative module is designed to evaluate different information (TR-ID, SW-ID) on the version of the device driver (TR) and the version of the device software (SW) and to identify existing conflicts with respect to nonequivalent functionality.

5. System configuration according to claim 1, in which the comparative module (CC, C) is designed to trigger an update mechanism for the device software (SW) and/or the device driver (TR).

6. System configuration according to claim 1, with an interface (I) for inputting the device driver and/or the device software from an external source, particularly from a data carrier or an external data file server.

7. Process in a control system for identifying nonequivalent functionality between a device software and an assigned device driver, in which
information (TR-ID) on the version of the device driver (TR) and/or information (SW-ID) on the version of the device software (SW) is transmitted between a device control mechanism (GC) and a device (G) over an interface (CI, GI) between the device control mechanism (GC) and the device (G),
the information (TR-ID) on the version of the device driver (TR) and the information (SW-ID) on the version of the device software (SW) are compared with respect to functional equivalence, and
an update is executed and/or an error notice is released when there is no functional equivalence.

8. Process according to claim 7, in which a data bank in the device control mechanism (GC) and/or in the device (G) is accessed for the purpose of comparison and, for every device function and/or every version of the device driver, information is stored on the version (SW-ID) of the device software (SW) starting with which the given device function or the given driver version is supported.

9. Process according to claim 7 in which linked to the version (SW-ID of the device software there is information on the version (TR-ID) of the device driver starting with which the functionality of the version (SW-ID) of the device software is completely contained, said information being employed for the purpose of comparison.

10. Process according to claim 7, in which the comparison is performed in conjunction with a connecting structure between the device control mechanism (GC) and the device (G) and/or between the device driver (TR) and the device software (SW).

11. Process according to claim 7, in which information (HWx) on the device hardware that is compatible with the device software (SW) or with the device driver (TR) is additionally linked to the device software version (SW-ID) and/or the device driver version (TR-ID).

12. Process according to, claim 7, in which an update mechanism for the device software (SW) and/or the device driver (TR) is automatically triggered in the case of incompatibility.

13. Process according to, claim 7, in which data and/or programs required for updating are loaded from an external source, particularly from a data carrier or an external data file server.

14. Process according to claim 7, in which the version of the device driver (TR) required by the device software (SW) is installed in the update.

15. Process according to claim 7, in which the newest available version of the device driver (TR) and/or of the device software (SW) is installed in the update.

16. Process according to claim 7, in which a selective list of available and matching versions of the device driver (TR) and/or of the device software (SW) is displayed to the user during the update, to permit selection of the versions to be installed.

17. Process according to, claim 7, in which the device software (SW) that matches the device driver (TR) is a component part of the device driver (TR) and this device software (SW) is transmitted directly into the device (G) by the device driver (TR).
